(19) United States
(12) Patent Application Publication
(10) Pub. No.: US 2015/0220316 A1
(43) Pub. Date: Aug. 6, 2015

(54) APPLICATION PROGRAM EVANESCENCE ON A COMPUTING DEVICE

(71) Applicant: Microsoft Corporation, Redmond, WA (US)

(72) Inventors: Dikla Dotan-Cohen, Netanya (IL); Liron Levin, Kfar-Saba (IL); Ishai Oren, Tel Aviv (IL); Haim Somech, Ramat Gan (IL)

(73) Assignee: Microsoft Corporation, Redmond, WA (US)

(21) Appl. No.: 14/170,534

(22) Filed: Jan. 31, 2014

(51) Int. Cl. G06F 9/445

(52) U.S. Cl. CPC G06F 8/62

(57) ABSTRACT

Application programs are automatically uninstalled from a computing device based upon contextual information that is inconsistent with their continued availability. Programs are purchased for a limited context where, once the context is no longer valid, the application program is automatically uninstalled. Alternatively, or in addition, context under which an application program is automatically uninstalled is user-specified when the application is initially purchased or installed, or at a subsequent time. Subsequently, users are notified when an application is uninstalled, or is about to be uninstalled. Such a notification provides the user with an opportunity to override the automatic uninstallation or, alternatively, or in addition, provides the user with access to alternative, or supplemental, application programs. Information associated with automatic application uninstallation is retained in an application manifest generated by the application author, or by processes executing on the computing device, and is stored as part of the application, or separately.

### BACKGROUND

Modern computing devices, especially smart phone computing devices and tablet computing devices, often implement a simplified user interface that presents a wide variety of content, such as different application programs, at a single hierarchical level, such as through multiple “screens” that a user can navigate to utilizing touch gestures or other like user input appropriate for a portable computing context. While such a simplified user interface can be utilized efficiently, especially in a portable computing context, when a user has installed a limited number of application programs and other content, users having a large number of application programs and content can find such a simplified user interface challenging. In particular, it can require additional effort on the part of the user to identify and locate a particular application program, or specific content. Users often have to resort to utilizing search functionality to identify and locate application programs and content that is sought, or, alternatively, users have to resort to flipping back and forth between multiple screens of information to identify and locate the application program and content that they seek.

Often, users have installed, on their computing devices, application programs that they no longer utilize, but have not undertaken the time and effort to remove or uninstall. More specifically, the ease with which application programs can be installed on modern computing devices, including network installation of such application programs through wireless communicational interfaces, can result in users installing application programs simply to evaluate such programs, or to utilize such programs only in limited circumstances. For example, a user may install an application program in the form of a game that the user may only play a few times before determining that the user is not fond of the game. As another example a user may install an application program providing a travel guide for a specific destination that the user does not intend to return to anytime soon. Unfortunately, users often do not invest the effort to uninstall applications that they no longer utilize. Such application programs can then clutter the user's device and cause the user difficulty in identifying and locating the application programs that the user does wish to utilize. Additionally, such application programs can consume valuable resources, including storage resources, processing resources, and other like computing resources. Furthermore, the existence of these applications on the user's device may also result in the user's device performing actions that are undesirable to the user. For example, such applications can present notifications or other interruptions that the user would prefer to avoid. As another example, such applications can promote recommendations for related applications that the user is not actually interested in.

### SUMMARY

In one embodiment, application evanescence can be provided for by automatically uninstalling from one or more computing devices based upon contextual information that is inconsistent with continued availability of such applications.

In another embodiment, users can be provided with the option of purchasing evanescent application programs that are present on the user's computing device for a limited context where, once such a context is no longer valid, the application program can be automatically uninstalled. Such purchase of evanescent applications can be associated with corresponding financial incentives, such as a lower purchase price.

In yet another embodiment, users can be provided with the option of specifying application evanescence, such as contextual conditions under which an application program can be automatically uninstalled. Such an option can be specified by the user when the application is initially purchased or installed, or at a subsequent point in time.

In a further embodiment, users can be notified when an application is uninstalled, or is about to be uninstalled. Such a notification can be utilized to provide the user with an opportunity to override the application's evanescence. Such a notification can, alternatively, or in addition, be utilized to provide the user with access to alternative, or supplemental, application programs. Such access to other application programs can include financial incentives, such as by providing the other application programs at a reduced cost, or offering less expensive or free application programs that provide analogous, or supplemental, functionality to the evanescent application that was uninstalled.

In a still further embodiment, information associated with evanescent applications can be retained in an application manifest that can be part of the evanescent application program itself, or which can be retained separately in an application manifest store. Such an application manifest can be generated by the application author, or it can be generated by processes executing on the computing device on which an application program corresponding to such a manifest is being installed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system providing for application program evanescence;

FIG. 2 is a mockup diagram of exemplary user interface sequences directed to evanescent application programs;

FIG. 3 is a flow diagram of an exemplary provision of application program evanescence; and

FIG. 4 is a block diagram of an exemplary computing device.

### DETAILED DESCRIPTION

The following description relates to evanescent application programs that can be automatically uninstalled from a computing device based upon contextual information that is inconsistent with continued availability of such evanescent applications. Application providers can make evanescent applications available to users, where such purchases can be associated with corresponding financial incentives, or can be otherwise desirable to users, such as under conditions where both evanescent application programs and permanent application programs have the same cost, including application programs whose funding derives primarily from advertisements. Alternatively, or in addition, users can be provided with the option of specifying application evanescence, such as contextual conditions under which an application program can be automatically uninstalled. Such an option can be specified by the user when the application is initially purchased or installed, or at a subsequent point in time. Subsequently, users can be notified when an application is uninstalled, or is about to be uninstalled. Such a notification can be utilized to provide the user with an opportunity to override the application's evanescence. Such a notification can, alternatively, or in addition, be utilized to provide the user with access to alternative, or supplemental, application programs. Such access to other application programs can include financial incentives, such as by providing the other application programs at a reduced cost, or offering less expensive or free application programs that provide analogous, or supplemental, functionality to the evanescent application that was uninstalled. Information associated with evanescent applications can be retained in an application manifest that can be part of the evanescent application program itself, or which can be retained separately in an application manifest store. Such an application manifest can be generated by the application author, or it can be generated by processes executing on the computing device on which an application program corresponding to such a manifest is being installed.

The techniques described herein focus on the automatic uninstallation of application programs from computing devices, where such application programs were originally installed by being downloaded to such computing devices from a centralized application marketplace, or store or installed as part of an automated task completion. However, such descriptions are not meant to suggest a limitation of the described techniques. To the contrary, the described techniques are equally applicable to any application program installed on any computing device, irrespective of the vector through which such an application program was installed on the computing device. Consequently, by way of example, and not limitation, the described techniques are equally applicable to application programs installed from computer-readable storage media physically coupled to a computing device, as well as application programs that are installed on a computing device at the time of manufacture or sale of such a computing device.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

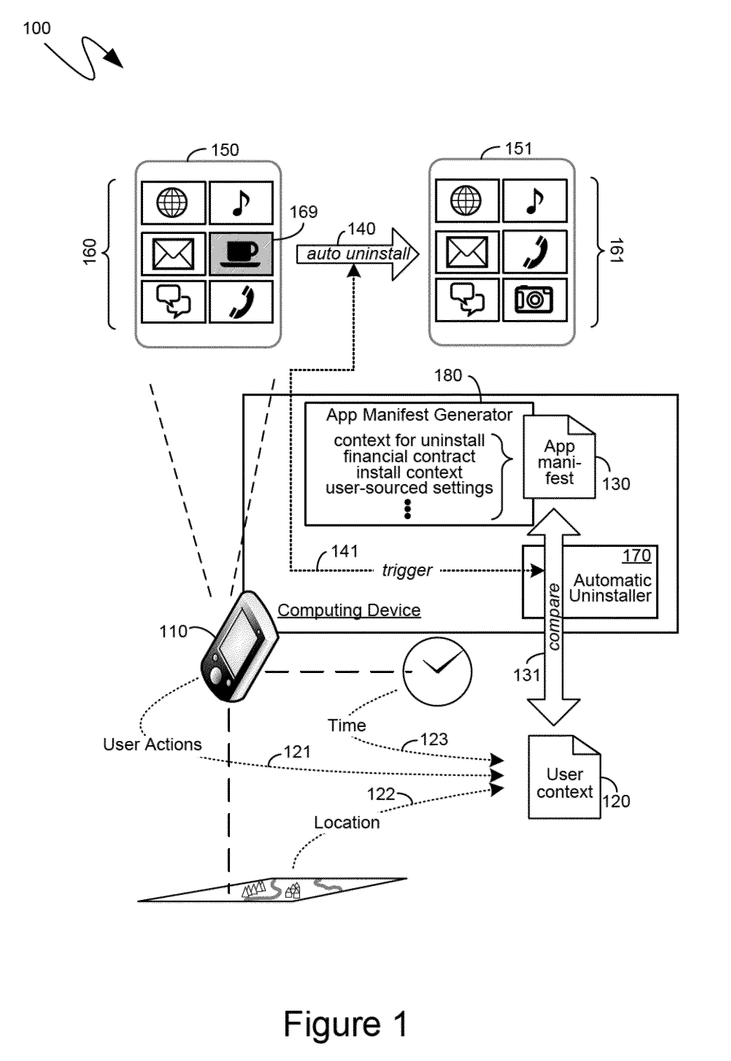

With reference to FIG. 1, an exemplary system 100 is illustrated, comprising a computing device 110 on which are installed multiple application programs, such as the application programs 160 whose icons are shown in the exemplary user interface 150. In one embodiment, a user context 120 can be generated from contextual information obtainable from the computing device 110. By way of example, and not limitation, such contextual information can include user actions 121 on the computing device 110, a current location 122 of the computing device 110, and a current time 123. The user context 120 can continually change, including due to changes in the current time 123, the current location 122 of the computing device 110, and user actions 121 being performed on the computing device 110.

An automatic uninstaller process 170, executing on the computing device 110, can compare, as illustrated by the compare action 131, the user context 120 with information associated with an application that can indicate when such an application is to be automatically uninstalled from the computing device 110. As utilized herein, the term “evanescent application” means an application program whose existence on a computing device is limited based on predefined contextual conditions. In one embodiment, information defining an application's evanescence can be retained in an application manifest, which can be stored as part of the evanescent application program itself, or can be retained separately, such as in an application manifest store or other like reserved storage area. One such application manifest is illustrated in FIG. 1 as the exemplary application manifest 130.

An application manifest, such as the exemplary application manifest 130, can, in one embodiment, be provided with the evanescent application program, such as when the application program is first installed on the computing device 110. For example, an application manifest can be included in an installation package that also comprises the evanescent application program, where such an installation package is downloaded to the computing device 110 and then unpackaged thereon to install the application program and, in the present example, the application manifest itself. As another example, the application manifest can be retained separately from the evanescent application program and the downloading of an evanescent application can automatically trigger the downloading of a corresponding application manifest, such as from a different portion of an application store or marketplace, or other like centralized application distribution mechanism.

In another embodiment, an application manifest, such as the exemplary application manifest 130, can be generated once an evanescent application program is installed on the computing device 110. For example, an application manifest can be generated on the computing device 110 by an application manifest generator 180, which can be part of the automatic uninstaller 170, or can be a separately executing component. An application manifest can be generated, such as by the application manifest generator 180, based upon information obtained at the time that the evanescent application program is installed on the computing device 100. Such information can include information that can be provided from the source of the evanescent application program, such as an application store or marketplace, or other like centralized application distribution mechanism. Alternatively, or in addition, such information can include information that can be obtained from the user, including information directly obtained from the user, such as through user interface notifications and subsequent responses provided by the user, and information obtained indirectly from the user, such as information gleaned from the user's actions or the user's general settings or roles.

In one embodiment, an application manifest, such as the exemplary application manifest 130, can specify specific contextual conditions defining the corresponding application program's evanescence. For example, the application manifest 130 can specify that a corresponding evanescent application program is to be automatically uninstalled from the computing device 110 when the location 122 of the computing device 110 is beyond a defined geographic area for more than a threshold amount of time. In such an example, a comparison 131, that can be made by the automatic uninstaller 170, between such an application manifest 130 and the user context 120, can reveal whether, and when, the computing device 110 has traveled beyond the defined geographic area for more than the specified threshold amount of time. If the comparison 131 reveals that the user context 120 is no longer compatible with continued retention of the evanescent application program on the computing device 110, based upon information contained in that application's manifest, such as the application manifest 130, such an evanescent application can be automatically uninstalled by the automatic uninstaller 170. Thus, as illustrated in the exemplary system 100 of FIG. 1, the comparison action 131 can trigger, as illustrated by the triggering 141, an automatic uninstallation of an evanescent application program by the automatic uninstaller 170, such as is illustrated by the automatic uninstall action 140. As illustrated in FIG. 1, the application 169 can be automatically uninstalled, which can result in the generation of an updated user interface 151, now comprising icons of applications 161 that do not include the evanescent application 169.

In another embodiment, an application manifest, such as the exemplary application manifest 130, can comprise information regarding a financial contract by which the cost that was paid for a corresponding evanescent application program is related to, and determined by, the conditions defining such an application program's evanescence. Returning to the above example, the application 169 can, in such an example, be an evanescent application whose evanescence is defined by a specific geographic area, such as a guide to coffee houses in a specific city. When purchasing such an exemplary evanescent application 169, a user of the computing device 110 can be provided with multiple purchasing options, including an option to purchase a permanent variant of the application 169, which can be at a higher cost, and the option to purchase an evanescent variant of the application 169, such as an evanescent variant of the application whose evanescence is based upon the user visiting that city. Such an evanescent application program can be at a lower cost. Alternatively, evanescent application programs need not carry financial incentives, and can, instead, be desirable to users precisely because they are evanescent and remove the burden from the user of having to manually uninstall such application programs. Should the user select and evanescent application program, the evanescent application, such as the exemplary evanescent application 169, can be installed on the computing device 110 and a corresponding application manifest, such as the exemplary application manifest 130, can be obtained or generated, which can specify that the evanescent application 169 is to be automatically uninstalled when the user of the computing device 110 leaves the city. More specifically, the application manifest could specify that the evanescent application 169 is to be automatically uninstalled when the location 122 of the computing device 110 is beyond a defined geographic region, such as, for example, a geographic region extending for a hundred miles from the center of the relevant city. Additionally, to prevent automatic uninstallation when the user only temporarily leaves the city, such as on a day-trip, the automatic uninstallation of the evanescence of the application 169 can be conditioned, not only on the computing device 110 having a location 122 that is beyond a defined geographic region, but also that the computing device 110 maintains a location 122 beyond such a defined geographic region for greater than a threshold amount of time such as, for example, one week. The automatic uninstaller 170 can continuously compare the current user context 120 to application manifests, such as the exemplary application manifest 130, as illustrated by the compare action 131, and when the compare action 131 reveals that the user context 120 is no longer consistent with an evanescent application's continued existence on the computing device 110, such as, in the present example, when the compare action 131 reveals that the user context 120 is indicative of the computing device 110 having a location 122 that is beyond the geographic region defined in the application manifest 130 for greater than the threshold amount of time defined in the application manifest 130, the compare action 131 can trigger 141 the automatic uninstaller 170 automatically uninstalling 140 the corresponding evanescent application program 169.

Automatic uninstallation information that can be retained in an application manifest, such as the exemplary application manifest 130, can include information that can be sourced from a user of the computing device 110. More specifically, in one embodiment, the user of the computing device 110 can specify, either when an application program is initially installed on the computing device 110, or at a subsequent time, one or more contextual circumstances defining the evanescence of such an application program. For example, the user can install an application program on the computing device 110 that the user intends to utilize only in a specific context, such as a context in which the user currently finds themselves. One such example was illustrated previously within the context of an application program providing a guide to coffee houses in a specific city. User of the computing device 110 could install such an application program utilize only while the user is visiting such a city. In such an example, a user could specify, such as at the time that the application is installed, or at a later time, that the user desires such an application to be uninstalled once the user leaves such a city. A corresponding application manifest, comprising information analogous to that detailed above, could be generated, except that such an application manifest could be generated on the computing device 110, such as by the application manifest generator 180, rather than being provided to the computing device 110 when the application was initially obtained. More specifically, the application manifest generator 180 can translate user input indicating that the user desires an application program to be evanescent by being uninstalled when the user leaves a particular city into the aforementioned requirements directed to the user's context being beyond the defined geographic region for greater than a defined threshold amount of time. Such requirements can then be stored in an application manifest, such as exemplary application manifest 130.

In another embodiment, automatic uninstallation information sourced from a user of the computing device 110 need not be directed to a specific application. Instead, a user of the computing device 110 can provide application-independent automatic uninstallation information. For example, a user can indicate that any game that the user has not played for user-defined period of time, such as one month, is to be automatically uninstalled. In such an example, the application manifests corresponding to each game application program installed on the computing device 110 can be modified by the application manifest generator 180 to include information indicating that if the user has not played the corresponding game within the user-defined period of time, then the game application program is to be automatically uninstalled. The comparison action 131 can then monitor the user context 120, such that, when the user actions 121 and the time 123, as indicated in the user context 120, are indicative of the user not having played the game for more than one month, then such a comparison action 131 can trigger 141 an automatic uninstallation 140 of such a game application program.

Application manifests, such as the exemplary application manifest 130, can comprise automatic uninstallation information that can be generated without explicit user input. For example, the application manifest generator 180 can store, into an application's manifest, information regarding the user context 120 at the time that such an application is installed on the computing device 110. Subsequent automatic uninstallation can then be based on whether the user context at the time that an application was installed on a computing device meaningfully varies from a current user context 120. In one embodiment, the automatic uninstallation information stored in the application manifest 130 can be based on the type of application. For example, applications having utility tied to a specific geographic region, a specific time, or other like contextual indicators can have the user context 120 at the time that such an application is installed in the computing device 110 stored into the application manifest 130. Additionally, the application manifest 130 can include specific triggers for automatic uninstallation that can be based on such a stored user context. For example, if the user downloads an application program providing a guide to a specific sporting event, such as a specific Olympic games, then the application manifest generator 180 can store information in the application manifest 130 that can be indicative of the user context 120 at the time that such an application was installed in the computing device 110. Further information can also be stored in the application manifest 130 that can be indicative of the end of such Olympic games or other like time-centric information associated with the specific, time-limited event to which the application is directed. The application manifest 130 can then comprise an indication that an automatic uninstallation of such an application is to be undertaken if a current time 123 is greater than a predefined period of time past the end of the time-limited event, such as the end of the Olympic games to which the application provided a guide.

The user context 120 at the time that an application is installed on the computing device 110 can also be meaningful when the application that is installed on the computing device 110 is a suggested application or an application that is automatically installed on the computing device 110 in the expectation that the user will find such an application desirable. More specifically, an application that is automatically installed on the computing device 110 is typically automatically installed because a user context 120 at the time that the application is automatically installed is deemed to be indicative of user interest in such an application. Consequently, such user context 120 at the time that the application is automatically installed can be logged by the application manifest generator 180 in the application's manifest 130 for subsequent evaluation. As the user context 120 changes, a current user context 120 can be different than the user context at the time that the application was automatically installed. In such an instance, the compare action 131 performed by the automatic uninstaller 170 can reveal whether the current user context 120 has meaningfully changed from the user context at the time that the application was automatically installed and, consequently, if the application has not been used by the user, or if the user has not otherwise indicated a desire to retain such an application, then the automatic uninstaller 170 can automatically uninstall the application.

In one embodiment, an application manifest can exist, such as by being downloaded with an evanescent application, or such as by being generated by the application manifest generator 180, for every application that is installed on a computing device 110 and, by default, such an application manifest can indicate that an application is to be uninstalled under a specific set of contextual circumstances such as, for example, contextual circumstances relating to user actions 121, location 122 of the computing device 110, a current time 123, or combinations thereof. If the user is desirous of retaining an application indefinitely, than the user can explicitly indicate such a desire, either without prompting, at any time prior to the automatic uninstallation of what would otherwise be an evanescent application program, or in response to an explicit notification indicating that such an otherwise evanescent application is to be automatically uninstalled in accordance with a default automatic uninstallation policy which, as indicated, can have been recorded in the application manifest 130 by the application manifest generator 180. In such an embodiment, a check can be made, prior to the application manifest generator 180 creating or amending an application manifest to specify for a default automatic uninstallation, to determine whether the application is a system application or is otherwise an application whose uninstallation can negatively impact the user's ability to utilize the computing device 110. For example, applications that are necessary for the operating system of the computing device 110 to function properly, or applications that are provided as part of a minimum set of applications installed on the computing device 110, can be exempted from the default automatic uninstallation.

The application manifest generator 180 can also generate application manifests by default that can comprise information indicative over when a corresponding evanescent application program is to be uninstalled. For example, evanescent application programs can be uninstalled by default if the user has not accessed such application programs for an extended period of time, such as greater than a predefined threshold period of time. As another example, evanescent application programs can be uninstalled by default if the user has not accessed such application programs for an extended period of time and such evanescent application programs consume system resources disproportionately to the user's utilization of such application programs. In such instances, the application manifest generator 180 can generate application manifests, or can append information to existing application manifests, which can specify, for example, threshold periods of time beyond which application programs should be uninstalled, or, as another example, threshold system resource consumption that, in combination with threshold periods of time, can be utilized to determine whether application programs should be uninstalled.

As indicated previously, in one embodiment, an automatic uninstaller 170 can continuously monitor a current user context 120 and can compare, as illustrated by the comparison action 131, the current user context 120 with application manifests, such as the exemplary application manifest 130, to determine whether evanescent applications associated with those application manifests are to be automatically uninstalled from the computing device 110. If the automatic uninstaller 170 determines that one or more evanescent applications are to be automatically uninstalled, the automatic uninstaller 170 can trigger 141 an automatic uninstallation 140 of such evanescent applications. Consequently, as a user utilizes the computing device 110 over time, and the user context 120 changes over time, the automatic uninstaller 170 can identify, over time, evanescent applications that are to be automatically uninstalled. For example, returning to the above example where an application manifest indicates that its corresponding evanescent application is to be automatically uninstalled once the computing device 110 has left a geographic region for more than a threshold amount of time, in such an example, the automatic uninstaller 170 can repeatedly compare the user context 120 to such an application manifest until a current time 123, as represented by the user context 120, exceeds the threshold amount of time that the location 122 of the computing device 110 has been beyond the defined geographic region. At such a point, the automatic uninstaller 170 can then trigger the automatic uninstallation 140 of an evanescent application program corresponding to such a manifest.

In one embodiment, application manifest generator 180 can provide an interface by which other processes, components, or applications can access an application manifest, such as the exemplary application manifest 130, and add or modify information retained therein. For example, the application manifest generator 180 can provide an interface by which external processes can update contextual triggers, in an application manifest, under which a corresponding application program is to be automatically uninstalled.

In a similar manner, the automatic uninstaller 170 can provide an interface by which other processes, components, or applications can trigger 141 an automatic uninstallation 140 of one or more application programs. For example, external processes can provide for other types of heuristic analysis that can identify application programs that are to be automatically uninstalled. Such jurisdiction analysis can be complementary to, or orthogonal to the comparison 131 made by the automatic uninstaller 170 between automatic uninstallation criteria specified in the application manifest, such as the application manifest 130, and information in a current user context 120.

Additionally, while the above descriptions have been provided with reference to the user context 120 which, as indicated, is illustrated as comprising a specific set of information, such as information based upon user actions 121, a location 122 of the computing device 110, and a current time 123, other information can equally be part of the user context 120 and can be utilized to trigger 141 an automatic uninstallation 140. For example, a user can establish a bandwidth allotment for themselves to ensure that they do not transmit or receive greater than a threshold amount of data through specific communicational channels, such as through wireless data services whose cost can be dependent upon the amount of data transmitted thereacross. In such an instance, application manifests associated with applications that transmit or receive data through such wireless services can be updated, such as via the application manifest generator 180, or interfaces provided thereby, to include information indicative of how much data such applications have transmitted or received. Additionally, the user context 120 can be updated with information regarding the aggregate amount of data transmitted or received through such wireless services by the computing device 110. Should the aggregate amount of data transmitted or received through such wireless services by the computing device 110 be greater than the user's threshold, an automatic uninstaller 170 can detect such a condition and can then evaluate application manifests, such as the exemplary application manifest 130, to identify applications that can be transmitting or receiving too much data, and can trigger 141 the automatic uninstallation 140 of such applications. Alternatively, or in addition, the automatic uninstaller 170 can provide interfaces by which external processes can detect data consumption and can evaluate application manifests to identify applications for automatic uninstallation.

As will be recognized by those skilled in the art, a user of the computing device 110 may own multiple other computing devices whose applications are synchronized where the applications that a user has installed on one computing device, such as the exemplary computing device 110, are also installed on other computing devices associated with such a user, or with such a user's account. In such an instance, in one embodiment, automatic uninstallation of an evanescent application program initiated from one computing device, such as the exemplary computing device 110, can trigger automatic uninstallation of that same evanescent application program from other computing devices that are associated with the same user as the exemplary computing device 110. Consequently, in such an embodiment, the triggering 141 of the automatic uninstallation 140 of an evanescent application program can be provided by the automatic uninstaller 170 in response to communications received, such as by the automatic uninstaller 170, from automatic uninstallers executing on others of the computing devices whose applications are synchronized together, such as by being associated with a common user account.

In one embodiment, automatic uninstallation of evanescent application programs can provide for a paradigm in which users conceptualize their ownership of application programs in a temporally limited manner, or evanescent manner, to the benefit of such users. For example, users acquiring evanescent application programs can know that such evanescent application programs will be uninstalled when they are no longer useful to such users. Consequently, such users can be more free to explore other application programs, especially other evanescent application programs, and, thereby, potentially gain greater utility from their computing devices. As another example, users acquiring evanescent application programs can conserve financial resources by purchasing computing devices having reduced storage or other like capabilities, since evanescent application programs can free storage resources on behalf of users. As still another example, users can be offered financial incentives to acquire evanescent application programs that will only temporarily be installed on such users' computing devices and will then be automatically uninstalled a subsequent point in time. More specifically, users can purchase such evanescent application programs for a reduced cost as compared with similar application programs that will not be automatically uninstalled.

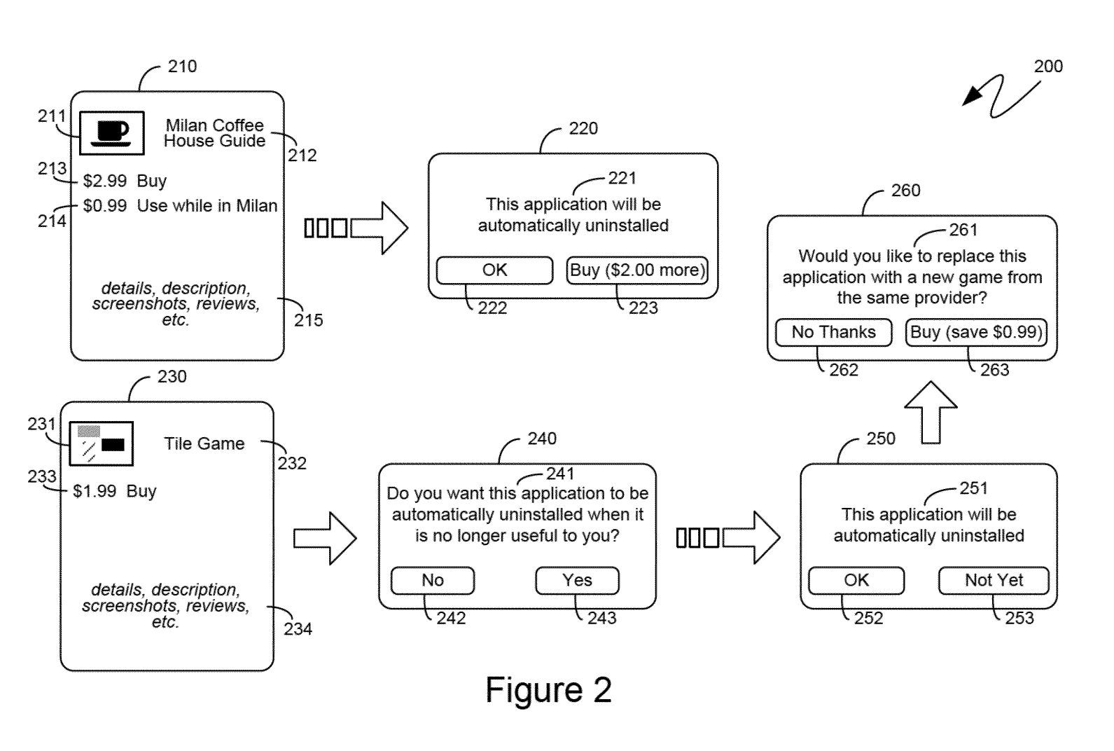

To facilitate user adoption of such paradigms, user interfaces can be presented by which a user can be informed of the temporally limited nature of evanescent application programs installed on their computing device, can be afforded control of such automatic uninstallations, and can be presented with financial incentives in accordance with the aforementioned automatic uninstallation. Turning to FIG. 2, the system 200 shown therein illustrates an exemplary series of user interfaces by which a user can participate in an evanescent application paradigm.

The exemplary user interface 210 illustrates one user interface by which a user can be provided with multiple purchasing options that can provide a financial incentive for purchasing evanescent applications that will be automatically uninstalled under predetermined contextual conditions. For example, the exemplary user interface 210 provides, to the user, an interface by which the user can purchase an evanescent application, whose icon 211, title 212, and corresponding information 215 are shown in the exemplary user interface 210. More specifically, the exemplary user interface 210 provides a user with a purchasing option 213 to purchase a permanent version of the identified application as well as a different purchasing option 214 that can be priced differently than the purchasing option 213, and which enables a user to purchase and evanescent version of the identified application. In one embodiment, the contextual circumstances defining the evanescence of the evanescent version of the identified application program can be indicated as part of the exemplary user interface 210. For example, in the illustrated example, purchasing option 214 indicates that the evanescent application will be available for the user's utilization while the user is in the geographic region to which the application is directed, and will be automatically uninstalled when contextual circumstances indicate that the user has left the geographic region.

If the user selects the purchasing option 214, a further user interface, such as the exemplary user interface 220, can be presented to the user to provide the user with opportunities to counteract the evanescence of an application program purchased utilizing the purchasing option 214. For example, the exemplary user interface 220 can indicate, such as via the notification 221, that a specific application either is about to be automatically uninstalled, or has already been automatically uninstalled. Additionally, the exemplary user interface 220 can provide the user with an option to purchase a permanent version of that same application program, such as for an additional fee. Thus, as illustrated by the exemplary user interface 220 in FIG. 2, the user can be provided with an option 223 that indicates the additional cost to purchase a permanent version that will not be automatically uninstalled, and allows the user to purchase such an application. Should the user not desire to do so, the user could select a non-purchasing option 222.

In another embodiment, users can be incentivized to purchase evanescent application programs, not due to financial considerations, such as reduced cost, as illustrated in the exemplary user interface 210, but rather due to the evanescent nature of evanescent application programs. More specifically, users can desire, or can find increased value precisely in the fact that evanescent application programs are evanescent, thereby removing the burden from the user to manually uninstall such application programs or otherwise remove them from the user's device. Additionally, users whose computing devices comprise defined limitations, such as limited storage capacity or limited bandwidth consumption capacity, may also perceive additional value in selecting evanescent application programs at purchase and install time. Consequently, while the exemplary user interface 210 illustrates two purchasing options, namely purchasing options 213 and 214, with the former being a purchasing option for a permanent version of the application program, and the latter being a purchasing option for an evanescent version of the application program, in other embodiments, only a single purchasing option, namely a purchasing option for only an evanescent version of the application program, could be offered. Alternatively, while two purchasing options could be offered, namely purchasing options for a permanent version of an application program and an evanescent version of the application program, such purchasing options need not differentiate in price, such as the exemplary purchasing options 213 and 214 shown in FIG. 2, and can, instead, offer different versions of the application program at the same price. As yet another alternative, due to the potential desirability of evanescent application programs, as detailed above, the purchase price for an evanescent version of an application program, such as the exemplary purchasing option 214, can, actually, be higher in cost than a purchasing option of a permanent version of the same application program, such as the exemplary purchasing option 213.

In a further embodiment, automatic uninstallation of evanescent application programs can be utilized as a mechanism by which the providers of application programs, such as application program developers, can offer analogous, or supplementary, application programs for purchase by the user. For example, the exemplary user interface 230, illustrates an exemplary presentation, to a user, of an application for purchase, the exemplary user interface 230 comprising an icon 231 of the application, a title 232 of the application, corresponding application information 234 and the application's purchase price 233.

Once a user purchases an application, such as through the exemplary user interface 230, the user can be presented with a subsequent user interface 240 that can provide the user with the opportunity to have the application automatically uninstalled. As indicated previously, the exemplary user interface 240 can be provided at the time that the user purchases the application, such as through the exemplary user interface 230, or it can be provided at a subsequent point in time. The notification 241, of the exemplary user interface 240, can be one of a sequence of notifications that presents, to the user, different options available to the user to define the evanescence of the application program. In addition to notifications, such as the exemplary notification 241, the user can be provided with selection options, such as the exemplary options 242 and 243. In such a manner, user can participate in defining the evanescence of application programs installed on the user's computing device.

In one embodiment, since the application purchased through the exemplary user interface 230 was not specifically purchased with financial consideration directed to its evanescence, when the application is to be automatically uninstalled, the user can be notified so that the user can respond to such an automatic uninstallation and, if appropriate, the user can take action to counteract the application's evanescence. For example, the exemplary user interface 250 illustrates one exemplary mechanism by which notification, such as the notification 251, can be provided to a user, thereby informing the user that an evanescent application is to be automatically uninstalled. In the embodiment described, the user can be provided with options, such as the option 252, to allow the evanescent application to be automatically uninstalled, or, alternatively, the option 253, by which the user can prevent, or delay, the automatic uninstallation of the evanescent application program.

As indicated, automatic uninstallation of application programs can be utilized as a mechanism by which the providers of application programs, such as application program developers, can offer analogous, or supplementary, application programs for purchase by the user. Thus, when an application, such as the application purchased through the exemplary user interface 230, is uninstalled, the user can be provided with a notification, such as via the exemplary user interface 260, by which complementary offers be made to the user. For example, as illustrated by the exemplary user interface 260, the user can be provided with an offer 261 to purchase a corresponding application program. Additionally, the exemplary user interface 260 can provide the user with options, such as the option 262 to the decline such an offer, or the option 263 to participate in such an offer. By way of example, a user purchasing a game, or other like application program whose desirability can be transient, can allow such a game to be automatically uninstalled, such as, for example, either in accordance with specific automatic uninstallation options selected by the user, or in accordance with default automatic uninstallation mechanisms. Upon the automatic uninstallation of such a game, the user can be afforded the opportunity to purchase other games, either other games similar to the game that the user purchased, or other games from the same provider, such as the same application developer. Such an embodiment can be particularly desirable for game developers, who are typically aware of the transient nature of their product and can utilize the above-described mechanisms to continually feed to users their latest efforts and derive therefrom a continuing revenue stream. Additionally, to entice users to accept the complementary offer, such as of purchasing another game from the same provider, a discount or other like monetary reward or incentive can be offered. In such an embodiment, the options 263, rather than presenting a specific price can, instead, present a discount or other like incentive to entice the user to accept the offer being made by the exemplary user interface 260.

Although not specifically illustrated in FIG. 2, the providers of application programs can be presented with an interface when initially making their applications available to users, such as by uploading such application programs to a centralized store, or other like distribution mechanism. Such an application providing interface can present options, analogous to those illustrated in FIG. 2, by which the providers of application programs can be presented with options defining the evanescence of their application programs. For example, such an application providing interface can enable providers of application programs to select from evanescence options, such as a version of their application program that can be automatically uninstalled under one or more contextual conditions. Additionally, such an application providing interface can enable providers of application programs to set differential pricing, or other like financial considerations, to differentiate between versions of their application program that remain until they are manually removed by a user, and evanescent version of their application program.

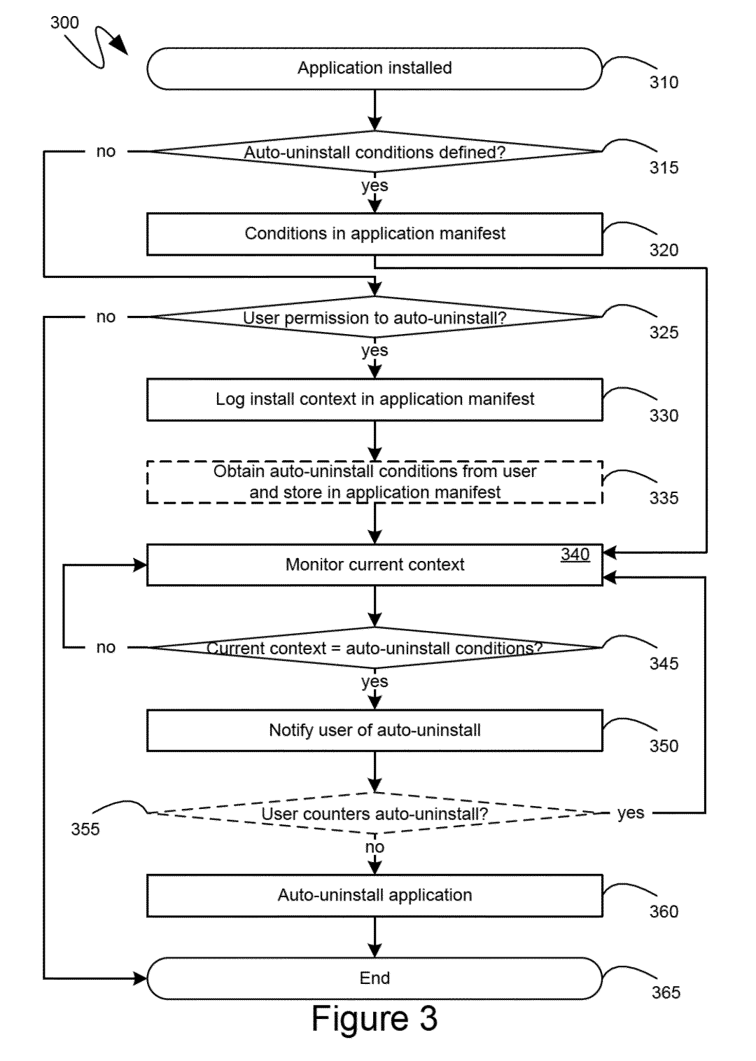

Turning to FIG. 3, an exemplary flow diagram 300 shown therein illustrates an exemplary series of steps that can be performed to facilitate application evanescence, such as that described in detail above. Initially, as illustrated by the exemplary flow diagram 300 of FIG. 3, at step 310, an application can be obtained by a user of a computing device and installed upon such a computing device. As indicated previously, the application installation, at step 310, can occur through the downloading of application programs from a centralized store or marketplace from which such application programs can have been purchased. Subsequently, at step 315, a determination can be made as to whether such an application is and evanescent application that is associated with automatic uninstallation instructions, conditions, parameters, or other like information defining the application's evanescence. If, at step 315, it is determined that the application installed at step 310 is an evanescent application, the automatic uninstallation conditions can be part of an application manifest that can be obtained at step 320, such as part of the original downloading of the evanescent application program from the centralized store, or other like analogous vectors. Processing can then skip to step 340, described in detail below.

Conversely, if, at step 315, it is determined that the application is a permanent application, processing can proceed to step 325, where the user can be queried to obtain permission to automatically uninstall the application program, thereby changing the application program into an evanescent application program. As indicated previously, the user can provide permission for default, or generic uninstallation conditions, or the user can specify specific contextual circumstances defining an application's evanescence. To illustrate such options available to the user, the exemplary flow diagram 300 of FIG. 3 illustrates an initial determination, at step 325, as to whether the user has granted permission that the application, installed at step 310, can be automatically uninstalled. If, at step 225, the user has granted such permission, the context of the user's computing device at the time that the application is installed, at step 310, can be codified in an application manifest, at step 330, to facilitate subsequent automatic uninstallation of the application. More specifically, and was described in detail above, heuristic analysis or other like comparisons between a subsequent context and the context at the time that the application was installed at step 310 can reveal whether and when the application is to be automatically uninstalled. Should the user desire to specify contextual conditions defining such an application's evanescence, then processing can also perform optional step 335 in obtaining such specific contextual conditions from the user and including the same in the application manifest.

Processing can proceed with step 340, where the current context of the user's computing device can be monitored. At step 345, this part of the monitoring of the current context at step 340, a determination can be made as to whether the current context matches contextual conditions under which one or more application programs are to be automatically uninstalled, such as is indicated by application manifests of those application programs. If, at step 345, it is determined that the current context does not meet any automatic uninstallation conditions, then processing can return back to the monitoring of the current context at step 340. Conversely, if, at step 345, it is determined that the current context does meet automatic uninstallation conditions of at least one application program, processing can proceed with step 350 at which point the user can be notified of the automatic uninstallation. As indicated previously, in one embodiment, the user can be afforded an opportunity to counter an application's evanescence. As also indicated previously, in other embodiments, the automatic uninstallation of application programs can be part of the financial contract entered into by the user when the user purchased the evanescent application program, such as, for example, evanescent application programs whose purchase price reflected such application programs' evanescence. In such embodiments, the user need not be provided with an opportunity to stop the automatic uninstallation.

If the user is afforded the opportunity to stop such an automatic uninstallation, the determination can be made, at optional step 255, as to whether the user stopped the automatic uninstallation. If the user did choose, at step 255, to stop the automatic installation, then processing can simply return to step 340. Conversely, if, at step 155, the user elects to allow the automatic uninstallation to proceed, or, alternatively, if the user is not afforded the opportunity to stop the automatic uninstallation and step 355 is not performed, then processing can proceed with step 360, at which point the application can be automatically uninstalled. The relevant processing can then end at step 365.

Although described in detail above within the context of application programs, the mechanisms described are equally applicable to other digital content stored and managed by a computing device. Thus, for example, digital content, such as digital photographs, word processing documents, components, libraries, and other like digital content can, such as in the manner described in detail above, be associated with manifests that can define the evanescence of such digital content. For example, a photograph can be associated with a manifest that can define the conditions under which such an evanescent photograph can be automatically removed. Consequently, references to application programs in the detailed descriptions above are meant to equally include other forms of digital content.

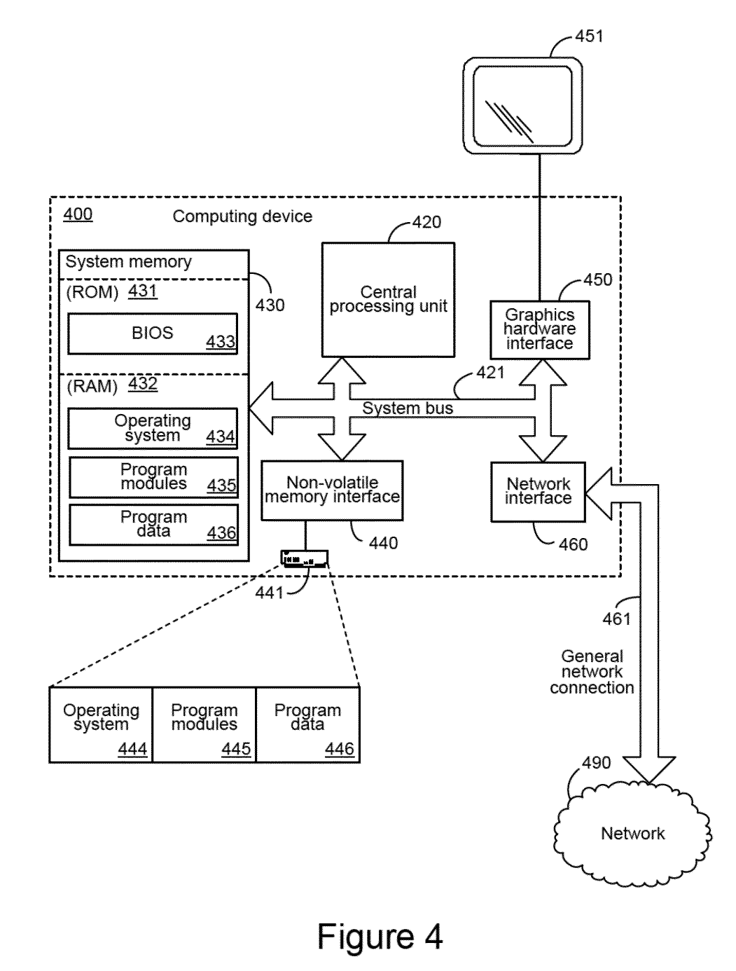

Turning to FIG. 4, an exemplary computing device 400 is illustrated which can perform some or all of the mechanisms and actions described above. The exemplary computing device 400 can include, but is not limited to, one or more central processing units (CPUs) 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. The computing device 400 can optionally include graphics hardware, including, but not limited to, a graphics hardware interface 450 and a display device 451, which can include display devices capable of receiving touch-based user input, such as a touch-sensitive, or multi-touch capable, display device. Depending on the specific physical implementation, one or more of the CPUs 420, the system memory 430 and other components of the computing device 400 can be physically co-located, such as on a single chip. In such a case, some or all of the system bus 421 can be nothing more than silicon pathways within a single chip structure and its illustration in FIG. 4 can be nothing more than notational convenience for the purpose of illustration.

The computing device 400 also typically includes computer readable media, which can include any available media that can be accessed by computing device 400 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computing device 400, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, other program modules 435, and program data 436.

The computing device 400 may also include other removable/non-removable, volatile/nonvolatile computer storage media. By way of example only, FIG. 4 illustrates a hard disk drive 441 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440.

The drives and their associated computer storage media discussed above and illustrated in FIG. 4, provide storage of computer readable instructions, data structures, program modules and other data for the computing device 400. In FIG. 4, for example, hard disk drive 441 is illustrated as storing operating system 444, other program modules 445, and program data 446. Note that these components can either be the same as or different from operating system 434, other program modules 435 and program data 436. Operating system 444, other program modules 445 and program data 446 are given different numbers hereto illustrate that, at a minimum, they are different copies.

The computing device 400 may operate in a networked environment using logical connections to one or more remote computers. The computing device 400 is illustrated as being connected to the general network connection 461 through a network interface or adapter 460, which is, in turn, connected to the system bus 421. In a networked environment, program modules depicted relative to the computing device 400, or portions or peripherals thereof, may be stored in the memory of one or more other computing devices that are communicatively coupled to the computing device 600 through the general network connection 661. It will be appreciated that the network connections shown are exemplary and other means of establishing a communications link between computing devices may be used.

As can be seen from the above descriptions, automatic uninstallation of application programs due to contextual circumstances have been presented. In view of the many possible variations of the subject matter described herein, we claim as our invention all such embodiments as may come within the scope of the following claims and equivalents thereto.

We claim:

1. One or more computer-readable media comprising computer-executable instructions for automatically uninstalling a first application program from a computing device, the computer-executable instructions directed to steps comprising:
comparing a computing device context to manifests associated with application programs, the computing device context comprising at least two of: a current time, a current geographic location of the computing device, and user actions on the computing device;
identifying, based on the comparing, a first manifest that defines contextual conditions under which the first application programs is to be automatically uninstalled, the contextual conditions defined by the first manifest matching the computing device context; and
automatically uninstalling the first application program based on the identifying.

2. The computer-readable media of claim 1, wherein the contextual conditions defined by the first manifest are based on a financial contract by which the first application program was purchased for a price less than that of a version of the first application program that would not be automatically uninstalled.

3. The computer-readable media of claim 1, wherein the contextual conditions defined by the first manifest comprise a location of the computing device being beyond a defined geographic area for a greater than a defined threshold amount of time.

4. The computer-readable media of claim 1, comprising further computer-executable instructions for generating, on a display device communicationally coupled to the computing device, a user notification of the automatic uninstallation of the first application program; wherein the computer-executable instructions for automatically uninstalling the application program are only executed if user permission is received in response to the user notification.

5. The computer-readable media of claim 1, comprising further computer-executable instructions for generating, on a display device communicationally coupled to the computing device, a user notification providing an opportunity to upgrade to a version of the first application program that would not be automatically uninstalled.

6. The computer-readable media of claim 1, comprising further computer-executable instructions for generating, on a display device communicationally coupled to the computing device, a user notification providing an opportunity to purchase a related application program in view of the first application program being automatically uninstalled.

7. The computer-readable media of claim 1, comprising further computer-executable instructions for downloading, to the computing device, the first application program together with the first manifest.

8. The computer-readable media of claim 1, comprising further computer-executable instructions for generating, on the computing device, the first manifest.

9. The computer-readable media of claim 8, wherein the computer-executable instructions for generating the first manifest comprise computer-executable instructions for generating the first manifest based upon user-specified contextual conditions.

10. The computer-readable media of claim 8, wherein the computer-executable instructions for generating the first manifest comprise computer-executable instructions for generating the first manifest based upon a computing device context at a time the first application program was installed on the computing device.

11. An user interface, displayed on display device communicationally coupled to a computing device, the user interface comprising:
a presentation of a first purchase option for an application program, the first purchase option lacking an explicitly defined automatic uninstallation of the application program from the computing device;
a presentation of a second purchase option for the application program, the second purchase option being of lower cost than the first purchase option, the second purchase option associated with an explicitly defined automatic uninstallation of the application program from the computing device; and
a subsequently presented notification informing of an automatic uninstallation of the application program and offering at least one of: an upgrade from the second purchase option to the first purchase option or a different financial term.

12. The user interface of claim 11, further comprising a second subsequently presented notification offering a related application program in view of the application program being automatically uninstalled.

13. The computer-readable media of claim 12, wherein the related application program is from a same provider as the application program being automatically uninstalled.

14. The user interface of claim 11, further comprising a presentation of user-selectable options defining contextual conditions under which the application program will be automatically uninstalled from the computing device.

15. A method for automatically uninstalling a first application program from a computing device, the method comprising the steps of:
comparing a computing device context to manifests associated with application programs, the computing device context comprising at least two of: a current time, a current geographic location of the computing device, and user actions on the computing device;
identifying, based on the comparing, a first manifest that defines contextual conditions under which the first application programs is to be automatically uninstalled, the contextual conditions defined by the first manifest matching the computing device context; and
automatically uninstalling the first application program based on the identifying.

16. The method of claim 15, wherein the contextual conditions defined by the first manifest comprise a location of the computing device being beyond a defined geographic area for a greater than a defined threshold amount of time.

17. The method of claim 15, further comprising the steps of: generating, on a display device communicationally coupled to the computing device, a user notification of the automatic uninstallation of the first application program; wherein the automatically uninstalling the application program is only performed if user permission is received in response to the user notification.

18. The method of claim 15, further comprising the steps of: generating, on a display device communicationally coupled to the computing device, a user notification providing an opportunity to purchase a related application program in view of the first application program being automatically uninstalled.

19. The method of claim 15, further comprising the steps of: generating, on the computing device, the first manifest based upon a computing device context at a time the first application program was installed on the computing device.

20. The method of claim 15, further comprising the steps of: downloading, to the computing device, the first application program together with the first manifest.
